(19) United States
(12) Patent Application Publication
(10) Pub. No.: US 2008/0006175 A1
(43) Pub. Date: Jan. 10, 2008

(54) Environmental-friendly and solvent-based inkjet ink composition

(75) Inventors: Ke-Yung King, Hsinchu City (TW); Chia-Kuei Ling, Hsinchu City (TW); Su-Jen Wang, Hsinchu City (TW); Yi-Ching Lu, Hsinchu City (TW)

Correspondence Address: RABIN & Berdo, PC, 1101 14TH STREET, NW, SUITE 500, WASHINGTON, DC, 20005, US

(73) Assignee: Jetbest Corporation, Hsinchu City (TW)

(21) Appl. No.: 11/594,773

(22) Filed: Nov. 9, 2006

(30) Foreign Application Priority Data
Jul. 7, 2006 (TW) 095124868

(51) Int. Cl. C09D 11/02; C09D 11/16

(52) U.S. Cl. 106/31.6; 106/31.13

(57) ABSTRACT

An environmental-friendly and solvent-based inkjet ink composition particularly well suited for use in an inkjet printer is provided. The inkjet ink composition includes a food-grade solvent that has a relatively high polarity, a dye or a pigment, a resin, a surfactant, a homogenizer, an emulsifier, a wetting agent, and an UV absorber. More specifically, a biodegradable food-grade solvent that has relatively high polarityc, a low-volatile and low-toxic polypropylene glycol monoalkyl ether homogenizer, a low-toxic glycol ether emulsifier, a high-boiling polyethylene glycol ether solvent, a fruit-smelling acetoacetate solvent, a food-grade scratch-resistant PVC resin, a weather-resistant acrylic resin, an UV absorber, and a non-harmful surfactant containing silicon or not containing silicon are used in the inkjet ink composition of the present invention.

### BACKGROUND OF THE INVENTION

1. Field of the Invention

The invention relates to an inkjet ink composition, and in particular to an environmental-friendly and solvent-based inkjet ink composition that has the basic components which are biodegradable and found no harmful to human bodies. Such an inkjet ink composition is suitable for use in both thermal and piezo printheads for inkjet printers.

2. The Prior Arts

Special attention is paid to the advertisement printing market in the age of digital image. In digital inkjet printing technology, high quality printing of graphics, characters, or letters is demanded. Nowadays, there are two fundamentally different types of printheads for inkjet printing: thermal, and piezo. Water-based pigment or dye ink can be used for thermal printheads. Water-based, oil-based, solvent-based pigment or dye ink can be optionally used for the piezo printheads depending on the materials of the printhead caps or the ink inlet pipes. The majority of thermal printheads are manufactured by HP, Canon, Kodak, and Lexmark. The majority of piezo printheads are manufactured by Roland, XAAR, Spectra, Epson, Toshiba, Seiko, Hitachi, Sharp, Mimaki, Infiniti, and Mutoh. However, the inkjet printers with piezo printheads occupy the majority of the printing market because many varieties of solvents can be used in the piezo printheads.

Out of the consideration for the environment, water-based pigment or dye inks are used almost exclusively in desk printer for home or office. The advantages of the water-based ink include high safety, high quality of output, and capability of printing in vivid color. The disadvantages of the water-based ink include poor weather-resistance and a need of cold lamination for waterproof performance; this can cause the costs to rise. Also, additional labor and materials are needed for the improvement of the weather-resistance. Furthermore, specific consumption materials are needed for high printing resolution. Therefore, high time and material consumption and high cost are the main weakness of water-based inks.

Solvent-based pigment inks are used for large outdoor advertising boards. The advantages of solvent-based pigment ink are that the organic solvents used in the solvent-based inks are usually very corrosive, which allows it to penetrate uncoated plastic substrate, and thereby have good adhesion to the substrate. Furthermore, if suitable resins are added to the solvent-based pigment ink, the finished prints will have excellent rub resistance and scratch resistance, and have outdoor durability of 1 to 3 years. Since the costs of the raw materials used for the solvent-based pigment ink are low, it is the preferred choice for the mass-produced printed advertisements. The disadvantages of the solvent-based pigment ink are that the pattern resolution is relative low because uncoated substrate is used, printed ink gloss on the substrates is low, the color space is small, and the printhead nozzles can be clogged by large pigment particles when the printer is operating. Moreover, solvents used for the solvent-based pigment ink, such as cyclohexanone, 2-ethoxyethyl acetate, isophorone, or methyl isobutyl ketone (MIBK), are pungent, corrosive and harmful to the human body. However, these solvents can help the ink stick to the uncoated substrate and have lower cost. Solvents used in the solvent-based pigment inks are extremely toxic if inhaled in a large amount. It can cause miscarriage among pregnant women and the male infertility are extremely toxic if inhaled in a large amount. Cancer may occur if one continues to expose in such toxic environment has been continuing for a long time. For example, the large amount of ethylene glycol ethers are usually used in industries such as semiconductor, electronic, coating, painting, printing, leather, canning, or detergent industry. The hazardous ethylene glycol ethers is colorless and non-pungent and can easily penetrate into skin. Researches have shows that overexposure to ethylene glycol ethers can cause infertility, spontaneous abortion, blood diseases, or abnormal growth (such as oaf).

### SUMMARY OF THE INVENTION

The objective of the present invention is to provide a solvent-based inkjet ink composition that is environmental-friendly and found no harmful to human bodies, and such a solvent-based inkjet ink composition is suitable for use in both thermal and piezo printheads for inkjet printers. The solvent-based inkjet ink composition of the present invention includes a resin and an UV absorber in order to improve its water fastness and the light fastness. As used in printing, the solvent-based inkjet ink composition shows the advantages of fully saturated hues, wide color space, brilliant colors, and high quality of printing output. In addition, the printing substrate for use in the present invention is not required to be coated.

To achieve above objectives, the present invention provides an inkjet ink composition, comprising at least one dye or pigment, at least one surfactant, at least one alkyl lactate solvent or acetoacetate solvent, at least one polypropylene glycol monoalkyl ether homogenizer or hydroxyketone homogenizer, at least one polyethylene glycol ether solvent, at least one glycol ether emulsifier, at least one UV absorber, at least one diluting agent, and at least one resin.

The advantages of solvent-based inkjet ink composition of the present invention are that: the solvents in use are extracted from edible plant, such solvents are environmental friendly and have high-polarity. The solvent can dissolve colorants and the PVC substrate as well. The most important thing is that the solvents used in the present invention is not corrosive to printhead nozzles, ink pipes, and other parts of the inkjet printer; therefore is suitable for use in both thermal and piezo printheads for inkjet printers. Note that the inkjet ink composition of the present invention can be applied to water-based and solvent-based printers without changing the ink pips or parts. The inkjet ink composition of the present invention provides the same saturated hues, wide color space, brilliant color and high quality of printing output as the water-based ink. Also, the inkjet ink composition of the present invention has improved scratch resistance and waterfastness so that glue-spreading and film-covering processes are not needed; therefore, delivery time for the prints is shortened. Furthermore, because the inkjet ink composition of the present invention is solvent-based and can be directly printed on the substrate, the machine and materials for film-covering or specific coating materials are not needed for use in printing. Consequently, the print cost is reduced. Although the solvent is expensive, dye ink that is at least twice cheaper than the pigment ink can be chosen for printing. Again, print cost can be reduced. Besides the fact that the inkjet ink composition of the present invention is suitable for use in both thermal and piezo printheads, its mechanical functions in printing and printing rate per unit of time are also increased,; as the result, the print cost will be greatly reduced when the solvent-based ink is used in mass printing. The inkjet ink composition of the present invention is not only suitable in the printing industry but also suitable for screen-printing industry.

More objectives, features, aspects, and advantages of the present invention will be described further below.

### DETAILED DESCRIPTION OF THE PREFERRED EMBODIMENT

The present invention provides an environmental-friendly and solvent-based inkjet ink composition, comprising (1) a dye or a pigment; (2) a silicon-containing wetting agent or surfactant which is used to effectively lower the surface tension to enable the ink to have excellent wetting capability so that the problems of void-shrinkage and poor adhesion will not occur; (3) a food-grade alkyl lactate solvent which is biodegradable, and mainly used in RUM wine, milk, grape wine, coconut wine, flavor additive, or used as a carrier; (4) an acetoacetate solvent which can be used as perfume or food additive, and the acetoacetate solvent can give off the smell of fruit when printing, and also can react well with the PVC material. Furthermore, the acetoacetate solvent are not corrosive to the printhead nozzles and the ink pipes, it can penetrate the substrate effectively and enhances the output printings; (5) a high-boiling and low-toxic polypropylene glycol monoalkyl ether used as a homogenizer and represented by a formula of H(—OC₃H₆)ₙ—OR, where R is an alkyl group having 1 to 4 carbon atoms, and n is an integer from 1 to 3; (6) a low-toxic hydroxyketone used as a homogenizer; (7) a high-boiling polyethylene glycol ether solvent represented by a formula of R₁—O(CH₂CH₂O)ₙ—R₂, where R₁ and R₂ are each independently an alkyl group having 1 to 4 carbon atoms, and n is an integer from 2 to 5; (8) a glycol ether emulsifier which can improve the adhesion of the ink to the substrate, and also can improve the abrasion resistance and the brightness of the ink on the substrate; (9) an UV absorber which is benzophenone or benzotriazole, and can improve the light fastness of dye ink; (10) a diluting agent used to adjust the viscosity of the ink; and (11) an acrylic resin which can improve the adhesion of the ink to the substrate, and also can improve the abrasion resistance and the weather resistance of the ink on the substrate.

The inkjet ink composition of the present invention, the dye or the pigment is present in an amount of from 0.1 to 10% of the total weight of the inkjet ink composition, the surfactant is present in an amount from 0.01 to 0.10% of the total weight of the inkjet ink composition, the alkyl lactate solvent is present in an amount not more than 40% of the total weight of the inkjet ink composition, the acetoacetate solvent is present in an amount not more than 50% of the total weight of the inkjet ink composition, the polypropylene glycol monoalkyl ether homogenizer is present in an amount not more than 15% of the total weight of the inkjet ink composition, the hydroxyketone homogenizer is present in an amount not more than 20% of the total weight of the inkjet ink composition, the polyethylene glycol ether solvent is present in an amount not more than 60% of the total weight of the inkjet ink composition, the glycol ether emulsifier is present in an amount not more than 20% of the total weight of the inkjet ink composition, the UV absorber is present in an amount of from 0.10 to 1.0% of the total weight of the inkjet ink composition, the diluting agent is present in an amount not more than 15% of the total weight of the inkjet ink composition, and the resin is present in an amount of from 0.1 to 10% of the total weight of the inkjet ink composition. On the other hand, the viscosity of the inkjet ink composition is in the range of 3.0 to 20 cps at ambient temperature, and the surface tension of the inkjet ink composition is in the range of 20 dynes/cm to 40 dynes/cm.

The basic components in the inkjet ink composition of the present invention comprises a colorant, a surfactant or a wetting agent, a solvent, a homogenizer, an emulsifier, an UV absorber, a diluting agent, and a resin. The solvent which is the main component of the inkjet ink composition of the present invention is usually present in an amount of from 65 to 90% by weight of the total weight of the inkjet ink composition. Conventionally, the most common solvents used in a solvent-based inkjet ink composition are ketones, such as cyclohexanone, isophorone, or methyl isobutyl ketone (MIBK). These ketones are high volatile, highly corrosive to the materials, and able to enhance the adhesion of the colorants to the printing substrate, and also these ketones are inexpensive. However, the drawbacks of these ketones are that their odor are very pungent, and they are harmful to human bodies and the environment. The toxicological information provided by the material safety data sheet shows these ketones are carcinogens, and highly toxic to the environment. However, the solvents and the additives used in the inkjet ink composition of the present invention are only corrosive to the printing materials for meeting the requirements of the printing quality, but are not corrosive to the printheads or ink pipes. The components of inkjet ink composition of the present invention are not harmful to human bodies and the environment, and have no pungent odor. The material safety data sheet shows these components used in the inkjet ink composition of the present invention are not carcinogens, and are biodegradable. Moreover, the major solvents used in the inkjet ink composition of the present invention are the environmental-friendly alkyl lactate and acetoacetate solvents which can be used as perfume or food additives and has a fruity scent when printing. Consequently, the safety of the user is ensured when they use the inkjet ink composition of the present invention.

With respect to the colorants, the solvent-based dye or pigment can be used in the inkjet ink composition of the present invention. The dye has the advantages of brilliant color, wide color space, and easily matching colors, but has disadvantages including: poor weather resistance, incapability of covering the color of the underneath layer due to the excellent transparency of the dye composed of one molecule, poor UV light resistance, and easily fading upon illumination. The amount of colorants used is preferably from 1.0% to 10% of the total weight of the inkjet ink composition.

Dye can be water-based or solvent-based. Typical dyes include azo dyes, metal complex salt dyes, naphtholic dyes, anthraquinone dyes, indigo dyes, quinoimine dyes, cyanine dyes, quinoline dyes, nitro dyes, nitroso dyes, benzoquinone dyes, naphthoquinone dyes, phthalocyanine dyes, and metal phthalocyanine dyes. If the above-mentioned dyes are used in an ink, they must be completely dissolved in a solvent to prevent the clogging of printhead nozzles. Furthermore, because the water-based inks can be absorbed by papers, the printing defect appearing as “deckle edge left” and “image blurring” will occur when they are used in printing. However, because the solvent-based dye inks can only be adsorbed to the printing paper surface like laser-printer carbon powder, they will not have the same printing defects as the water-based inks. Because the oil-based inks can not be absorbed by a paper, the sharp printed images will be obtained when they are used in printing. Aqueous dyes are water-soluble and have poor waterfastness, and thereby the images printed by a typical desk printer will not be identified if water is accidentally dropped thereon. In the inkjet ink composition of the present invention, a waterfast solvent-based dye and a resin are used, and when the resin is used in the inkjet ink composition, the interaction between the colorant and the substrate can be further enhanced by it, and also a protection film can be formed on the printed images which would improve the waterfastness and scratch resistance.

The difference between pigment and the dye is that the pigment is large and composed of 10,000 molecules, and the pigment particles are irregular in size and shape, and when the light is reflected from the particles' irregular surface, it can make the color of the pigment to appear not as vivid as the color of the dye. However, the advantages for using pigment is that: its molecular structure is stable; its color fades slowly; and its weather resistance is good. The pigment can not be dissolved in a solvent, but can be evenly dispersed in a solvent, and thereby the suitable wetting and dispersing agents must be added during pigment milling so that the pigment can be evenly dispersed in the solvent. The dispersing agents are commonly added to the pigment dispersion to facilitate the deaggregation of the pigment particles in order to maintain the colloidal particle stability, and to retard particle reagglomeration through van der Waals force and settling down. If the pigment particles are brought together by van der Waals force and form larger agglomerates which can be observed by the naked eyes, the problem of non-uniform coloring and clogging of the printhead nozzles will happen. The pigment milling technology and its cost are higher than those of the dye processing. As a result, the pigment ink price is at least twice as high as the dye ink price. Nevertheless, the pigment inks still are the best choice for printing large outdoor advertising boards due to their excellent weather resistance and waterfastness.

Examples of the colorants used in the inkjet ink composition of the present invention include, but are not limited to, Savinyl Dye™ series colorants manufactured by Clarian Corp, such as Yellow 79, Yellow 83:1, Yellow 83, Yellow 62, Orange 41, Orange 62, Red 92, Red 89, Red 124, Red 122, Red 8, Red 91, Red 127, Violet 66, Blue 45, Blue 44, Black 27, or Black 45; the colorants manufactured by Arimoto Chemical Co., Ltd, such as Solvent Yellow 16, Solvent Yellow 14, Solvent Orange 80, Solvent Red 24, Solvent Red 27, Solvent 23, Solvent Blue 35, Solvent Green 3, Solvent Yellow 93, Solvent Yellow 33, Solvent Yellow 157, Solvent Orange 60, Solvent Red 111, Solvent Red 135, Solvent Red 168, Solvent Red 207, Solvent Red 52, Solvent Red 179, Solvent Blue 36, Solvent Violet 13, Solvent Blue 94, Solvent Blue 63, Solvent Blue 59, Solvent Blue 87, Solvent Green 20, Solvent Violet 13, Solvent Violet 36, Solvent Green 5, Solvent Orange 55, Solvent Orange 63, Solvent Red 149, or Solvent Red 150; Bayscript® Macrolex® and Bayplast series colorants manufactured by Bayer Co., such as Bayscript Black SP liq. (black), Bayscript Cyan BA liq. (blue), Bayscript Yellow GGN (yellow), Bayscript Yellow BR (yellow), Bayscript Magenta VPSP 25005 (magenta), Bayscript Magenta VPSP 25032 (magenta), Bayscript Black VPSP 20016 (pigment black for the inkjet printer ink), Bayscript Cyan VPSP 25033 (blue), Bayscript Yellow VPSP 20017 (yellow), Bayscript Yellow VPSP 20018 (yellow), or Bayscript Magenta VPSP 20015 (magenta); and the colorants for plastics, such as Macrolex Red EG Gran (red), Macrolex Red E2G Gran (red), Macrolex Red 5B Gran (red), Macrolex Red G Gran (red), Macrolex Red Violet R Gran (red violet), Macrolex Violet B Gran (violet), Macrolex Orange 3G Gran (orange), Macrolex Orange R Gran (orange), Macrolex Yellow 3G Gran (yellow), Macrolex Yellow 6G Gran (yellow), Macrolex Yellow G Gran (yellow), Bayplast Yellow 5G Gran (yellow), Bayplast Yellow G (green), Macrolex Green 5B Gran (green), Macrolex Blue 3R Gran (blue), Macrolex Blue RR Gran (blue), Macrolex Fluorescent Yellow 10GN (fluorescent yellow), or Macrolex Fluorescent Red G) (fluorescent red).

Examples of the organic dispersing pigments used in the inkjet ink composition of the present invention include, but are not limited to, Yellow 1, Yellow 3, Yellow 12, Yellow 13, Yellow 14, Yellow 17, Yellow 65, Yellow 73, Yellow 74, Yellow 75, Yellow 81, Yellow 83, Yellow 97, Yellow 126, Yellow 127, Yellow 139, Yellow 150, Yellow 151, Yellow 154, Yellow 174, Yellow 176, Yellow 180, Yellow 183, Yellow 188, Orange 5, Orange 13, Orange 16, Orange 34, Orange 36, Red 2, Red 3, Red 4, Red 8, Red 9, Red 12, Red 14, Red 21, Red 22, Red 23, Red 31, Red 48:1, Red 48:2, Red 48:3, Red 48:4, Red 49:1, Red 49:2, Red 52:1, Red 52:2, Red 53:1, Red 53:3, Red 57:1, Red 63:1, Red 81, Red 112, Red 122, Red 144, Red 146, Red 166, Red 170, Red 171, Red 175, Red 176, Red 177, Red 179, Red 184, Red 185, Red 208, Red 210, Red 243, Red 266, Violet 1, Violet 3, Violet 19, Violet 23, Violet 27, Blue 1, Blue 15:1, Blue 15:2, Blue 15:3, Blue 15:4, Blue 56, Blue 61, Green 7, and Black 7. Examples of the inorganic pigments include, but are not limited to, Pigment Yellow 32, Pigment Yellow 34, Pigment Yellow 36, Pigment Yellow 42, Pigment Red 101, Pigment Red 104, Pigment Blue 27, Pigment Blue 29, Pigment Green 17, Pigment Black 11, and Pigment Orange 21.

With respect to the surfactants, the surfactants are used to reduce the surface tension of the ink so that the ink can have good covering capabilities. The amount of surfactants used is 0.1% to 1.0% by weight based on the total weight of the inkjet ink composition. The surfactants can be divided into four groups, according to their ionic nature: anionics, cationics, nonionics and amphoterics, and most of them are hydrocarbon, fluorocarbon, or silicone compounds. The surfactant molecules are amphiphilic molecules which can arrange themselves at the surface of the liquid such that the polar parts interacts with the liquid and the non-polar parts are held above the surface (in the air). The presence of these molecules on the surface disrupts the cohesive energy at the surface, and thus lowers the surface tension. Generally, the surface of any substrate has surface energy (mN/m), and examples of the typical substrates include polyesters (43 mN/m), polyethylene (36 mN/m), polypropylene (30 mN/m), and paraffin wax (26 mN/m). The surface tension of the ink should be lower than that of the substrate in order to make the ink have good covering capabilities. The non-toxic polymeric wetting agents are used in the inkjet ink composition of the present invention, and examples of the non-toxic polymeric wetting agent include Perenol® series leveling agents, manufactured by Henkel Corp.; polyether siloxane copolymer in TEGO® WET series, manufactured by TEGO Corp.; EFKA®-73 leveling agents containing silicon, manufactured by EFKA Corp.; or GE silicones in Coatosil® series, manufactured by Crompton Corp. The above-mentioned wetting agents can effectively reduce the surface tension of the ink to 20-40 (mN/m), allowing better coverage of the PVC substrates with the ink and eliminating the bubble generation to prevent the printhead nozzles from overheating which can lead to printhead damage.

Examples of the surfactants added singly or in combination to the inkjet ink composition of the present invention include, but are not limited to, polyether siloxane copolymer under trade names: TEGO® Wet 245, Wet 250, Wet 260, Wet 265, Wet 270, and Wet 280; Copolyacrylate under trade names: Perenol® F3, F40, F41, and F45; polysiloxane copolymer under trade names: Perenol® S4, and S43; silicone wetting agent under trade names: CoatOsil® 1211, 1300, 1706, 1757, 1770, 2400, 2810, 3500, 3501, 3503, 3505, 3509, and 3573; and organically modified polysiloxane under trade names: EFKA®-7310, 7311, 7315, 7316, 7340, 7361, 7375, 7381, and 7390.

With respect to the wetting agent, the printhead nozzles are exposed in the ambient environment whether they are in use or not. When the solvent in the inkjet ink composition is evaporated, the dried ink residues may clog the printhead nozzles, which will cause printhead nozzle clogging or deflected jetting. Therefore, a wetting agent, which is usually high boiling solvent, is added to the inkjet ink composition to help prevent the ink from drying out, or from crusting in the nozzle orifices of the printhead caused by the slow-down of the solvent evaporation. The wetting agent may be employed in an amount of 50% or less by weight of the total weight of the inkjet ink composition.

With respect to the alkyl lactate solvents and the acetoacetate solvents, the alkyl lactate solvents and the acetoacetate solvents can be added individually or in combination to the inkjet ink composition of the present invention, which give off a fruit scent when printing, and have a high reactivity with the substrate but are not corrosive to the printheads and ink pipes. Examples of alkyl lactate solvents include, but are not limited to, DL-lactate, ethyl lactate, propyl lactate, isopropyl lactate, butyl lactate, and hexyl lactate. Examples of the acetoacetate solvent include, but are not limited to, benzyl acetoacetat, butyl acetoacetate, tert-butyl acetoacetate, isobutyl acetoacetate, ethyl acetoacetate, isopropyl acetoacetate, methyl acetoacetate, 2-methoxyethyl acetoacetate, propyl acetoacetate, and isopropyl acetoacetate.

With respect to the dispersing agents and the homogenizer, the solvent-based dye has the physical properties intermediated between those of the organic phase and the water phase. Therefore, based on “Likes dissolve Likes” law, in order to dissolve the solvent-based dye, the solvent used in the present invention must be miscible with both the organic solvent and water. The polypropylene glycol monoalkyl ethers used in the present invention has similar properties as the polyethylene glycol ethers except that it is colorless, not pungent, and low in toxic level. Recently, the polypropylene glycol monoalkyl ethers are more commonly used for environmental protection reason.

The steric stabilization mechanisms contribute to the development of dispersing agents. The dispersing agents are polymers having functional groups. One end of the polymeric dispersing agent is successfully anchored to the pigment surface, and another end is extended into the mixture of the resin and the solvent on the pigment surface. As the wetted pigment particles approach each other, these adsorbed polymer chains are repelled from one another, and thereby the steric stabilization can prevent the pigment particles from aggregating. In order to understand the effect of the presence of the organic solvent and the resin on the pigment particle dispersion, the inkjet ink composition of the present invention including the dispersing agent, the resin, and the pigment are kept in the thermostated bath at 45° C. to perform the accelerated test. The test results show that the pigment particles do not precipitate and the viscosity of the inkjet ink composition varies slightly in the presence of the dispersing agent. Therefore, the test results prove the pigment can be evenly and stably dispersed in the inkjet ink composition of the present invention without precipitation in the presence of the dispersing agent.

The low-toxic polypropylene glycol monoalkyl ethers and hydroxyketones are used in the inkjet ink composition of the present invention as homogenizer. The polypropylene glycol monoalkyl ethers used in the present invention are represented by a formula of H(—OC₃H₆)ₙ—OR, where R is an alkyl group having 1 to 4 carbon atoms, and n is an integer from 1 to 3. These polypropylene glycol monoalkyl ethers can be used individually or in combination of two or more depending on the desired boiling point and the desired solubility of the inkjet ink composition of the present invention. Examples of the polypropylene glycol monoalkyl ether as a homogenizer include, but are not limited to, propylene glycol methyl ether, propylene glycol mono-n-propyl ether, propylene glycol mono-n-butyl ether, propylene glycol mono-t-butyl ether, propylene glycol monophenyl ether, dipropylene glycol methyl ether, dipropylene glycol mono-n-butyl ether, dipropylene glycol mono-t-butyl ether, dipropylene glycol mono-n-propyl ether, tripropylene glycol methyl ether, tripropylene glycoln-mono-n-propyl ether, tripropylene glycol mono-n-butyl ether. Furthermore, examples of the low-toxic hydroxyketone as a homogenizer include, but are not limited to, 4-hydroxy-4-methyl-2-pentanone, 3-hydroxy-3-methyl-2-butanone, and 4-hydroxy-3-methyl-2-butanone. These hydroxyketones can be used individually or in combination of two or more depending on the desired solubility of the colorants used in the present invention. Among them, 4-hydroxy-4-methyl-2-pentanone (synonyms:diacetone alcohol) is a colorless or light-yellow liquid with a lovely smell. The material safety data sheet shows 4-hydroxy-4-methyl-2-pentanone is not a carcinogen, and found no harm to the environment. 3-hydroxy-3-methyl-2-butanone, which can be used as perfume additive, has high polarity and relatively high solubility. The toxicological information provided by the material safety data sheet shows 3-hydroxy-3-methyl-2-butanone is not harmful to human bodies and the environment.

With respect to the polyethylene glycol ether solvents, the polyethylene glycol ether solvents used in the inkjet ink composition of the present invention have a formula of R₁—O(CH₂CH₂O)ₙ—R₂, where R₁ and R₂ are each independently alkyl groups having 1 to 4 carbon atoms, and n is an integer from 2 to 5. The boiling points of the polyethylene glycol ether solvents are 180 to 280° C., and they can be used individually or in combination depending on the desired boiling point and the solubility of the inkjet ink composition. The glycol ether type solvents have good solubility in comparison with various kinds of aqueous or organic solvents, and also they are able to stabilize the colorant in the ink. The glycol ethers have high boiling points, high polarities, and relatively high solubility so that they are often used in ink, dye, oil and cleaner applications. However, overexposure to glycol ethers may cause effects including symptoms of central nervous system depression, such as drowsiness, headache, unusually fatigue, loss of coordination, and the like. Long-term inhalation of glycol ethers may cause anemia, bone marrow suppression, brain diseases, and the like. The high boiling polyethylene glycol ethers used in the present invention are not pungent and can provide adequately strong wetting effect to prevent the nozzles of the printhead from clogging besides they have the above-mentioned advantages. Such polyethylene glycol ethers are corrosive to the PVC substrates. An instant adhesion between the ink and the printing substrate is accelerated when the printing substrates are preheated during printing, and thereby the ink diffusion phenomenon is alleviated, so the printing resolution is increased, and the printing quality is enhanced. These polyethylene glycol ethers can be used both as a wetting agent and as a solvent. The toxicological information provided by the material safety data sheet shows these polyethylene glycol ethers are not carcinogens, and are low toxic to human bodies and livestocks, and thereby the safety are greatly enhanced by using these polyethylene glycol ethers. Examples of the polyethylene glycol ether solvent include, but are not limited to, diethylene glycol dibutyl ether, diethylene glycol diethyl ether, diethylene glycol ethyl methyl ether, diethylene glycol dimethyl ether, triethylene glycol dimethyl ether, and tetraethylene glycol dimethyl ether.

With respect to the glycol ether emulsifiers, the glycol ether emulsifiers can improve the adhesion of the ink to the substrate, and also can improve the abrasion resistance and the brightness of the ink on the substrate. Examples of the glycol ether emulsifier include 3-phenoxy-1-propanol, 1-phenoxy-2-propanol, and 2-phenoxypropanol. The above-mentioned glycol ether emulsifiers are environmental-friendly film-forming agents and have wetting and dispersing ability.

With respect to the UV absorbers, the color of the dye fades easily when exposed to light because the dye is composed of small molecules, and thereby the dye has high transparency and poor UV resistance when dissolved. Examples of the UV absorber used in the inkjet ink composition of the present invention include benzophenone, and benzotriazole. The UV absorber is used to prevent UV light from damaging the colorants, and thereby the light-fastness of the colorants is enhanced. For example, 2-(2′-hydroxy-5′-methylphenyl)benzotriazole as UV absorber is FDA approved for use in food-contact applications, and found no harm to human bodies and the environment. Examples of the UV absorber include, but are not limited to, benzophenones, such as 2,4-dihydroxybenzophenone, 2-hydroxy-4-methoxy-benzophnone, or 2-hydroxy-4-n-octoxy benzophenone; benzotriazoles, such as 2-(2′-hydroxy-5′-methylphenyl)benzotriazole, 2-(3′-t-butyl-2′-hydroxy-5′-methylphenyl)-5-chlorobenzotriazole, 2-(2′-hydroxy-3′,5′-di-tert-amylphenyl)benzotriazole, 2-(2′-hydroxy-3′,5′-di-t-butylphenyl)-5-chloro-benzotriazole, 2-[2′-hydroxy-3′,5′-di(1,1-dimethylbenzyl)phenyl]-2H-benzotriazole, 2-(2′-hydroxy-3′,5′-di-t-butyl-phenyl)benzotriazole, 2-(2′-hydroxy-3′-sec-butyl-5′-tert-butylphenyl)benzotriazole, 2,2′-methylenebis[6-(2H-benzotriazol-2-yl)-4-(1,1,3,3-tetramethylbutyl)phenol]2H-benzotriazole, 2-[2-hydroxy-3,5-di(1,1-dimethylbenzyl)phenyl]2H-benzotriazole; N-(ethoxycarbonyl phenyl)-N′-methyl-N′-phenyl methyl ether; or N-(ethoxycarbonyl phenyl)-N′-ethyl-N′-phenyl methyl ether. These UV absorbers can help slow down the rate of fading of the colorants exposed to UV.

The diluting agent is used in the present invention for adjusting the viscosity of the ink. Examples of the diluting agent include, but are not limited to methanol, ethanol, and 2-propanol.

With respect to the resins, the resins are used in the present invention for adjusting the viscosity of the inkjet ink composition, and the amount of resins used is 10% or less by weight based on the total weight of the inkjet ink composition in order to meet the specification of the printhead and to improve the scratch resistance, waterfastness, brightness, and weather resistance of the inkjet ink composition. There are various kinds of commercially available resins. The resins used in the inkjet ink composition of the present invention include UCAR™ solution vinyl resins available from Dow Chemical Company. UCAR™ solution vinyl resins are FDA approved for use in food-contact applications, and have a molecular weight in the range of 22,000 to 50,000. These vinyl resins have a glass transition temperature (Tg) in the range of 70 to 80° C. These vinyl resins can be softened under high pressure and high temperature conditions at printhead, and solidified at room temperature after ink jetting. The UCAR™ solution vinyl resins have excellent scratch resistance and waterfastness, and also have excellent adhesion to PVC substrates, and the strength of the resin film formed on the PVC substrates is strong. Therefore, the UCAR™ solution vinyl resins will be the best choice to be used in the inkjet ink composition because 80% or more of the substrates used in printing are made of PVC, or coated with PVC.

Examples of the resin used in the inkjet ink composition of the present invention include, but are not limited to, UCAR™ solution vinyl resins available from Dow Chemical Company, i.e. vinyl chloride/vinyl acetate copolymer under trade names: VYHH, VYNS-3, VYNC-P, and VYLF-X; carboxyl-modified vinyl copolymer under trade names: VMCH, and VMCA; hydroxyl-modified vinyl copolymer under trade names: VAGD, VAGF, VAGC, VAGH, and VROH; and epoxy-modified vinyl copolymer under trade name VERR-40. These resins can be used individually or in combination of two or more depending on the desired scratch resistance, waterfastness, and brightness of the ink. VINNOL® surface coating resins available from Wacker Company, which include E15-40A, E1545, E15-45M, E15-48A, E22-48A, H11-59, H14-36, H15-42, H15-45M, H15-50M, H40-43, H40-50, H40-55, and H40-60, can improve the scratch resistance and the brightness of the ink, it also can improve the adhesion of the ink to the substrate. These resins can be used individually or in combination of two or more. The acrylic resins, such as the polymer of methyl methacrylate, the polymer of butyl methacrylate, or the copolymer of methyl methacrylate and butyl methacrylate, can be used in the inkjet ink composition of the present invention for improving the scratch resistance and the weather resistance of the ink, and the adhesion of the ink to the substrate. Examples of the acrylic resins used in the inkjet ink composition of the present invention include, but are not limited to, DEGALAN® acrylic resins available from Degussa Company, such as P 24, P 28, PM 381, PM 555, LP AL 23, LP 51/03, LP 66/02, MB 319, or M 345; PLEXIGUM® acrylic resins, such as M 825; PARALOID® acrylic resins available from Rohm and Hass company, such as A 11, or B 82; NeoCryl® acrylic resins available from DSM, such as B-723, B-725, B-728, B-736, B-805, B-810, B-811, B-890, or B-891. These resins can be used individually or in combination of two or more.

The inkjet ink composition of the present invention is suitable for use in commercially available thermal and piezo printheads. The preheated temperature of piezo printhead is set to 45° C. Several different printers with piezo printheads can be used in the present invention. Examples of the printer used in the present invention include Roland SJ-745 EX, Mimaki JV3-160 SP, and Mutoh RH-II K Plus, and the printing modes are 1400×1400 dpi-16 pass, 1080×1080 dpi-8 pass, 720×720 dpi-8 pass, 360×720 dpi-4 pass, 360×450 dpi-2 pass, or 360×360 dpi-1 pass. Examples of the piezo printheads are Mutoh 2216 Spectra 256, and its printing mode is 360×360 dpi-4 pass; Infiniti 8250 XAAR 128, and its printing mode is 200 dpi-2 pass; and Wit color 3316 XAAR 128, and its printing mode is 360 dpi-3 pass. Examples of the thermal printheads include HP Designjet 5500 and Encad NovaJet 700 set to standard printing mode.

Examples of the printing substrate used in the present invention include Solvent Glossy PP Paper, Solvent Luster PP Paper, Solvent Luster Vinyl Paper, Solvent Glossy Vinyl Paper, Solvent Photo Paper, Art Canvas, Canvas, and Mesh Vinyl Paper.

The following examples are presented for illustrative purposes only, and not intended as a restriction on the scope of the invention.

### EXAMPLE 1

The solvent-based inkjet ink composition are prepared by mixing 3.5% by weight of blue pigment, 0.05% by weight of surfactant, 10% by weight of glycol ether solvent, 10% by weight of hydroxyketone solvent, 40% by weight of alkyl lactate solvent, 22% by weight of acetoacetate solvent, 10% by weight of diluting agent, 0.5% by weight of UV absorber, and 4% by weight of resin (as listed in Table 1). This solvent-based inkjet ink composition is suitably applied to EPSON™ printhead.

TABLE 1

| Components | Percentage by weight |
|---|---|
| Blue pigment | 3.5% |
| Surfactant | 0.05% |
| Glycol ether solvent | 10% |
| Hydroxyketone solvent | 10% |
| Alkyl lactate solvent | 40% |
| Acetoacetate solvent | 22% |
| Diluting agent | 10% |
| UV absorber | 0.5% |
| Resin | 4% |
| total | 100% |

The viscosity of this solvent-based inkjet ink composition is measured on a Brookfield DV-E model Digitial Viscometer at 25° C. The surface tension is measured on a CBVP-A3 tension meter, manufactured by Kyowa Kaimenkagaku Co., Ltd. The particle size distribution of this inkjet ink composition is measured by HORIBA LB-550 Particle Size Distribution Analyzer. The chromaticity coordinate graph is obtained using a Nippon Denshoku's spectrophotometer (SA 2000) operated in L* a* b* color space, wherein L*, a*, and b* denote psychometric lightness, psychometric hue, and psychometric chroma coordinates, respectively. The pH value is measured with a calibrated pH meter. The alcohol resistance test is carried out by rubbing the inked pattern with ethanol-soaked cotton stick for 5 passes, and then it is visually examined to see whether the rubbed inked pattern is discolored or not. The scrub resistance test is carried out by scrubbing the inked pattern back and forth for 10,000 passes using a Wet Abrasion Scrub Tester 5005. The brightness of the ink on the printing substrate is measured using BYK micro gloss 60 Glossmeter, and the printing substrate used is made of a PVC material, i.e. Solvent Glossy Vinyl. High-temperature test is carried out by filling this solvent-based inkjet ink composition in a wide mouth bottle, and exposing it to 60° C. for one week and then to room temperature. After that, the properties of the solvent-based inkjet ink composition are examined, and the examined properties should be the same as the original one. Low-temperature test is carried out by filling this solvent-based inkjet ink composition in a wide mouth bottle, and exposing it to 5° C. for one week and then to room temperature. After that, the properties of the solvent-based inkjet ink composition are examined, and the examined properties should be the same as the original one.

The viscosity, surface tension, chromaticity coordinates, pH value, alcohol resistance, scrub resistance, brightness, and the odor test results for the solvent-based inkjet ink composition in Table 1 are listed in Table 5.

### EXAMPLE 2

The solvent-based inkjet ink composition are prepared by mixing 2% by weight of red pigment, 0.05% by weight of surfactant, 10% by weight of glycol ether solvent, 10% by weight of hydroxyketone solvent, 40% by weight of alkyl lactate solvent, 23.5% by weight of acetoacetate solvent, 10% by weight of diluting agent, 0.5% by weight of UV absorber, and 4% by weight of resin (as listed in Table 2). This solvent-based inkjet ink composition is suitably applied to EPSON™ printhead.

TABLE 2

| Components | Percentage by weight |
|---|---|
| Red pigment | 2% |
| Surfactant | 0.05% |
| Glycol ether solvent | 10% |
| Hydroxyketone solvent | 10% |
| Alkyl lactate solvent | 40% |
| Acetoacetate solvent | 23.5% |
| Diluting agent | 10% |
| UV absorber | 0.5% |
| Resin | 4% |
| total | 100% |

The same viscosity, surface tension, chromaticity coordinates, pH value, alcohol resistance, scrub resistance, brightness, and the odor tests as EXAMPLE 1 are repeated for the solvent-based inkjet ink composition prepared according to Table 2, and the test results are listed in Table 5.

### EXAMPLE 3

The solvent-based inkjet ink composition are prepared by mixing 2.6% by weight of yellow pigment, 0.05% by weight of surfactant, 10% by weight of glycol ether solvent, 10% by weight of hydroxyketone solvent, 40% by weight of alkyl lactate solvent, 18.6% by weight of acetoacetate solvent, 10% by weight of diluting agent, 0.5% by weight of Uw absorber, and 8.25% by weight of resin (as listed in Table 3). This solvent-based inkjet ink composition is suitably applied to EPSON™ printhead.

TABLE 3

| Components | Percentage by weight |
|---|---|
| Yellow pigment | 2.6% |
| Surfactant | 0.05% |
| Glycol ether solvent | 10% |
| Hydroxyketone solvent | 10% |
| Alkyl lactate solvent | 40% |
| Acetoacetate solvent | 18.6% |
| Diluting agent | 10% |
| UV absorber | 0.5% |
| Resin | 8.25% |
| total | 100% |

The same viscosity, surface tension, chromaticity coordinates, pH value, alcohol resistance, scrub resistance, brightness, and the odor tests as EXAMPLE 1 are repeated for the solvent-based inkjet ink composition prepared according to Table 3, and the test results are listed in Table 5.

### EXAMPLE 4

The solvent-based inkjet ink composition are prepared by mixing 5.3% by weight of black pigment, 0.05% by weight of surfactant, 16% by weight of glycol ether solvent, 42.5% by weight of alkyl lactate solvent, 22% by weight of acetoacetate solvent, 10.6% by weight of diluting agent, 0.5% by weight of UV absorber, and 3% by weight of resin (as listed in Table 4). This solvent-based inkjet ink composition is suitably applied to EPSON™ printhead.

TABLE 4

| Components | Percentage by weight |
|---|---|
| Black pigment | 5.3% |
| Surfactant | 0.05% |
| Glycol ether solvent | 16% |
| Alkyl lactate solvent | 42.5% |
| Acetoacetate solvent | 22% |
| Diluting agent | 10.6% |
| UV absorber | 0.5% |
| Resin | 3% |
| total | 100% |

The same viscosity, surface tension, chromaticity coordinates, pH value, alcohol resistance, scrub resistance, brightness, and the odor tests as EXAMPLE 1 are repeated for the solvent-based inkjet ink composition prepared according to Table 4, and the test results are listed in Table 5.

The viscosity, surface tension, chromaticity coordinates, pH value, alcohol resistance, scrub resistance, brightness, and the odor test results for the solvent-based inkjet ink composition respectively prepared from Examples 1, 2, 3, and 4 are shown in Table 5.

TABLE 5

| | | | chromaticity | pH | | | | |
|---|---|---|---|---|---|---|---|---|
| | viscosity | surface tension | coordinate | value | alcohol | scrub | brightness | |
| | (cps) | (dyne/cm) | (L*a*b*) | (pH) | resistance^{(a)} | resistance^{(b)} | (60°) | odor |
| Example 1 | 4.56 | 29.9 | 43.31, −11.91, −48.76 | 6.90 | − | + | 60 | fruit-smelling |
| Example 2 | 4.72 | 29.7 | 35.28, 64.62, 17.22 | 7.01 | − | − | 77 | fruit-smelling |
| Example 3 | 4.48 | 30.1 | 74.92, 2.75, 85.16 | 6.84 | − | + | 78 | almond-smelling |
| Example 4 | 5.44 | 29.4 | 6.00, 1.86, −4.56 | 6.50 | − | + | 58 | fruit-smelling |

^{(a)}Alcohol resistance, −: slightly discoloration, −−: badly discoloration, and +: no discoloration.
^{(b)}Scrub resistance, −: slightly discoloration, −−: badly discoloration, and +: no discoloration.

The viscosity of the solvent-based inkjet ink composition of the present invention is in the range of 3.0 to 20 cps at ambient temperature, and the surface tension of it is in the range of 20 dynes/cm to 40 dynes/cm. In the solvent-based inkjet ink composition of the present invention, the pigment is present in an amount from 0.1 to 10% by weight, the surfactant is present in an amount from 0.1 to 1.0% by weight, the solvent is present in an amount of from 60 to 90% by weight (inclusive of 20 to 40% by weight of the wetting agent), and the resin is present in an amount of from 0.5 to 10% by weight based on the total weight of the solvent-based inkjet ink composition.

In comparison with the conventional inkjet ink composition, the present invention provides a solvent-based inkjet ink composition which is not carcinogen, and is low toxic to human bodies and livestocks. Besides, the solvent-based inkjet ink composition of the present invention is not pungent, and has excellent scrub resistance, light fastness, and waterfastness, and can also guarantee high printing quality. The addition amount of each component depends on the desired ink color, and the specification of the printhead in use. These components can be used individually or in combination of two or more. The solvent-based inkjet ink composition of the present invention can be applied to various kinds of thermal and piezo printheads of the printers, and can be printed on various kinds of the printing substrates.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. An inkjet ink composition, comprising at least one dye or pigment, at least one surfactant, at least one alkyl lactate solvent or acetoacetate solvent, at least one polypropylene glycol monoalkyl ether homogenizer or hydroxyketone homogenizer, at least one polyethylene glycol ether solvent, at least one glycol ether emulsifier, at least one UV absorber, at least one diluting agent, and at least one resin.

2. The inkjet ink composition as claimed in claim 1, wherein the dye or the pigment is present in an amount of from 0.1 to 10% by weight of the total weight of the inkj et ink composition, the surfactant is present in an amount of from 0.01 to 0.10% by weight of the total weight of the inkjet ink composition, the alkyl lactate solvent is present in an amount not more than 40% by weight of the total weight of the inkjet ink composition, the acetoacetate solvent is present in an amount not more than 50% by weight of the total weight of the inkjet ink composition, the polypropylene glycol monoalkyl ether homogenizer is present in an amount not more than 15% by weight of the total weight of the inkjet ink composition, the hydroxyketone homogenizer is present in an amount not more than 20% of the total weight of the inkjet ink composition, the polyethylene glycol ether solvent is present in an amount not more than 60% of the total weight of the inkjet ink composition, the glycol ether emulsifier is present in an amount not more than 20% by weight of the total weight of the inkjet ink composition, the UV absorber is present in an amount from 0.10 to 1.0% by weight of the total weight of the inkjet ink composition, the diluting agent is present in an amount not more than 15% by weight of the total weight of the inkjet ink composition, and the resin is present in an amount of from 0.1 to 10% of the total weight of the inkjet ink composition.

3. The inkjet ink composition as claimed in claim 1, wherein the surfactant contains silicon.

4. The inkjet ink composition as claimed in claim 1, wherein the the surfactant does not contain silicon.

5. The inkjet ink composition as claimed in claim 1, wherein the alkyl lactate solvent is selected from the group consisting of methyl DL-lactate, ethyl lactate, propyl lactate, isopropyl lactate, butyl lactate, and hexyl lactate.

6. The inkjet ink composition as claimed in claim 1, wherein the polypropylene glycol monoalkyl ether has a formula of H(—OC₃H₆)ₙ—OR, where R is an alkyl group having 1 to 4 carbon atoms, and n is an integer from 1 to 3.

7. The inkjet ink composition as claimed in claim 1, wherein the hydroxyketone homogenizer is selected from the group consisting of 4-hydroxy-4-methyl-2-pentanone, 3-hydroxy-3-methyl-2-butanone, and 4-hydroxy-3-methyl-2-butanone.

8. The inkjet ink composition as claimed in claim 1, wherein the polyethylene glycol ether solvent has a formula of R₁—O(CH₂CH₂O)ₙ—R₂, where R₁ and R₂ are each independently alkyl groups having 1 to 4 carbon atoms, and n is an integer from 2 to 5.

9. The inkjet ink composition as claimed in claim 1, wherein the acetoacetate solvent is selected from the group consisting of benzyl acetoacetate, butyl acetoacetate, tert-butyl acetoacetate, isobutyl acetoacetate, ethyl acetoacetate, isopropyl acetoacetate, methyl acetoacetate, 2-methoxyethyl acetoacetate, propyl acetoacetate, and isopropyl acetoacetate.

10. The inkjet ink composition as claimed in claim 1, wherein the glycol ether emulsifier is selected from the group consisting of 3-phenoxy-1-propanol, 1-phenoxy-2-propanol, and 2-phenoxypropanol.

11. The inkjet ink composition as claimed in claim 1, wherein the UV absorber is benzophenones, or benzotriazoles.

12. The inkjet ink composition as claimed in claim 1, wherein the surfactant is selected from the group consisting of polyether siloxane copolymer, polyacrylate copolymer, polysiloxane copolymer, silicone wetting agent, and polysiloxane-modified polymer.

13. The inkjet ink composition as claimed in claim 1, wherein the resin is selected from the group consisting of vinyl chloride/vinyl acetate copolymer, carboxyl-modified vinyl copolymer, hydroxyl-modified vinyl copolymer, epoxy-modified vinyl copolymer, polymer of methyl methacrylate, the polymer of butyl methacrylate, and the copolymer of methyl methacrylate and butyl methacrylate,

14. The inkjet ink composition as claimed in claim 1, wherein the polyethylene glycol ether solvent has a boiling point in the range of 180 to 280° C.

15. The inkjet ink composition as claimed in claim 1, wherein the resin has a molecular weight in the range of 10,000 to 150,000, and the resin has a glass transition temperature in the range of 70 to 120° C.

16. The inkjet ink composition as claimed in claim 1, wherein the inkjet ink composition has a viscosity in the range of 3.0 to 20 cps at ambient temperature, and the inkjet ink composition has a surface tension in the range of 20 to 40 dynes/cm.

17. A low-toxic and non-pungent inkjet ink composition, comprising at least one dye or pigment, at least one surfactant, at least one alkyl lactate solvent or acetoacetate solvent, at least one polypropylene glycol monoalkyl ether homogenizer or hydroxyketone homogenizer, at least one polyethylene glycol ether solvent, at least one glycol ether emulsifier, at least one UV absorber, at least one diluting agent, and at least one resin.

18. The inkjet ink composition as claimed in claim 17, wherein the dye or the pigment is present in an amount from 0.1 to 10% by weight of the total weight of the inkjet ink composition, the surfactant is present in an amount of from 0.01 to 0.10% by weight of the total weight of the inkjet ink composition, the alkyl lactate solvent is present in an amount not more than 40% by weight of the total weight of the inkjet ink composition, the acetoacetate solvent is present in an amount not more than 50% by weight of the total weight of the inkjet ink composition, the polypropylene glycol monoalkyl ether homogenizer is present in an amount not more than 15% by weight of the total weight of the inkjet ink composition, the hydroxyketone homogenizer is present in an amount not more than 20% by weight of the total weight of the inkjet ink composition, the polyethylene glycol ether solvent is present in an amount not more than 60% by weight of the total weight of the inkjet ink composition, the glycol ether emulsifier is present in an amount not more than 20% by weight of the total weight of the inkjet ink composition, the UV absorber is present in an amount of from 0.10 to 1.0% by weight of the total weight of the inkjet ink composition, the diluting agent is present in an amount not more than 15% by weight of the total weight of the inkjet ink composition, and the resin is present in an amount of from 0.1 to 10% by weight of the total weight of the inkjet ink composition.

19. The inkjet ink composition as claimed in claim 17, wherein the surfactant contains silicon.

20. The inkjet ink composition as claimed in claim 17, wherein the the surfactant does not contain silicon.

21. The inkjet ink composition as claimed in claim 17, wherein the alkyl lactate solvent is selected from the group consisting of methyl DL-lactate, ethyl lactate, propyl lactate, isopropyl lactate, butyl lactate, and hexyl lactate.

22. The inkjet ink composition as claimed in claim 17, wherein the polypropylene glycol monoalkyl ether has a formula of H(—OC₃H₆)ₙ—OR, where R is an alkyl group having 1 to 4 carbon atoms, and n is an integer from 1 to 3.

23. The inkjet ink composition as claimed in claim 17, wherein the hydroxyketone homogenizer is selected from the group consisting of 4-hydroxy-4-methyl-2-pentanone, 3-hydroxy-3-methyl-2-butanone, and 4-hydroxy-3-methyl-2-butanone.

24. The inkjet ink composition as claimed in claim 17, wherein the polyethylene glycol ether solvent has a formula of R₁—O(CH₂CH₂O)ₙ—R₂, where R₁ and R₂ are each independently alkyl groups having 1 to 4 carbon atoms, and n is an integer from 2 to 5.

25. The inkjet ink composition as claimed in claim 17, wherein the acetoacetate solvent is selected from the group consisting of benzyl acetoacetate, butyl acetoacetate, tert-butyl acetoacetate, isobutyl acetoacetate, ethyl acetoacetate, isopropyl acetoacetate, methyl acetoacetate, 2-methoxyethyl acetoacetate, propyl acetoacetate, and isopropyl acetoacetate.

26. The inkjet ink composition as claimed in claim 17, wherein the glycol ether emulsifier is selected from the group consisting of 3-phenoxy-1-propanol, 1-phenoxy-2-propanol, and 2-phenoxypropanol.

27. The inkjet ink composition as claimed in claim 17, wherein the UV absorber is benzophenones, or benzotriazoles.

28. The inkjet ink composition as claimed in claim 17, wherein the surfactant is selected from the group consisting of polyether siloxane copolymer, polyacrylate copolymer, polysiloxane copolymer, silicone wetting agent, and polysiloxane-modified polymer.

29. The inkjet ink composition as claimed in claim 17, wherein the resin is selected from the group consisting of vinyl chloride/vinyl acetate copolymer, carboxyl-modified vinyl copolymer, hydroxyl-modified vinyl copolymer, epoxy-modified vinyl copolymer, polymer of methyl methacrylate, the polymer of butyl methacrylate, and the copolymer of methyl methacrylate and butyl methacrylate,

30. The inkjet ink composition as claimed in claim 17, wherein the polyethylene glycol ether solvent has a boiling point in the range of 180 to 280° C.

31. The inkjet ink composition as claimed in claim 17, wherein the resin has a molecular weight in the range of 10,000 to 150,000, and the resin has a glass transition temperature in the range of 70 to 120° C.

32. The inkjet ink composition as claimed in claim 17, wherein the inkjet ink composition has a viscosity in the range of 3.0 to 20 cps at ambient temperature, and the inkjet ink composition has a surface tension in the range of 20 to 40 dynes/cm.

33. A low-toxic and non-pungent inkjet ink composition, characterized in that it comprises at least one polyethylene glycol ether solvent having a formula of R₁—O(CH₂CH₂O)ₙ—R₂, where R₁ and R₂ are each independently alkyl groups having 1 to 4 carbon atoms, and n is an integer from 2 to 5.

34. A low-toxic and non-pungent inkjet ink composition, characterized in that it comprises at least one acetoacetate solvent selected from the group consisting of benzyl acetoacetate, butyl acetoacetate, tert-butyl acetoacetate, isobutyl acetoacetate, ethyl acetoacetate, isopropyl acetoacetate, methyl acetoacetate, 2-methoxyethyl acetoacetate, propyl acetoacetate, and isopropyl acetoacetate.

35. A low-toxic and non-pungent inkjet ink composition, characterized in that it comprises at least one alkyl lactate solvent selected from the group consisting of methyl DL-lactate, ethyl lactate, propyl lactate, isopropyl lactate, butyl lactate, and hexyl lactate.

36. A low-toxic and non-pungent inkjet ink composition, characterized in that it comprises at least one glycol ether emulsifier selected from the group consisting of 3-phenoxy-1-propanol, 1-phenoxy-2-propanol, and 2-phenoxypropanol.
